(19) United States
(12) Patent Application Publication
(10) Pub. No.: US 2006/0170618 A1
(43) Pub. Date: Aug. 3, 2006

(54) DRIVING METHOD AND DRIVING CIRCUIT OF PLASMA DISPLAY PANEL

(76) Inventors: Chun-Lun Pan, Tainan City (TW); Chun-Hsu Lin, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,098

(22) Filed: Feb. 3, 2005

(51) Int. Cl. G09G 3/28

(52) U.S. Cl. 345/60

(57) ABSTRACT

A driving method and a driving circuit of a plasma display panel are provided. The driving circuit comprises a calculating unit, a gain unit, and a control unit, wherein the calculating unit is used for receiving an image signal to output a first display loading corresponding to the image signal. The gain unit is used for receiving the first display loading and by multiplying the first display loading with a gain constant, and then a second display loading is outputted. Furthermore, the control unit is used for receiving the second display loading to correspondingly output a sustain frequency. The power consumption of the plasma display panel is conformed to a rated value by driving with the sustain frequency.

### BACKGROUND OF THE INVENTION

1. Field of the Invention

The present invention relates to a driving method and a driving circuit of plasma display panel. More particularly, the present invention relates to a driving method and a driving circuit for adjusting the power consumption of display panels.

2. Description of Related Art

A picture frame displayed on the conventional plasma display panels comprises a plurality of sub-fields, wherein each sub-field comprises a reset period, an address period and a sustain period. The residual wall charge of the former sub-field is cancelled during the reset period, so that each display unit of the plasma display panels has the same initial condition in order to have a uniform display. In addition, an address pulse is applied to an address electrode during the address period and a scan pulse is inputted into a scan electrode in sequence at the same time to accumulate the wall charge of the pre-display unit. Furthermore, a sustain pulse is alternatively applied to the scan electrode and the sustain electrode during the sustain period, so that the display unit with the wall charge keeps on discharging. The brightness of the sub-field is directly proportional to the time-length of the sustain period. Accordingly, the picture frame will have different display gray levels due to the assembly of different display brightness of these sub-fields.

Generally speaking, the power consumption of plasma display panels during their sustain period is directly proportional to the product multiplied by the display loading and the sustain frequency, wherein the sustain frequency represents the most number of the sustain pulses can be afforded in a picture frame. The display loading is the ratio of the quantity of the lightening sustain pulses to the quantity of the provided sustain pulses in one picture frame. For example, the display loading is 0 while the panels display all black, whereas the display loading is 1 while the panels display all white. Therefore, in the same display loading, when the sustain frequency is increased, the quantity of the sustain pulse used in a picture frame will increase and the higher power consumption is achieved. Hence, in order to effectively control the power consumption during the sustain period, the power output is controlled by an automatic control power curve. FIG. 1 is a relationship diagram of the sustain frequency and the display loading while a conventional plasma display panel is driven. Referring to FIG. 1, the automatic control power curve 102 is the relationship curve of the sustain frequency and the display loading, wherein the power consumption of the plasma display panels can be controlled under a certain value by means of the display loading and the corresponding sustain frequency of the automatic control power curve 102. For example, when a plasma display panel receives an image signal, a display loading is obtained from calculation and the corresponding sustain frequency can be determined from the automatic control power curve. The power consumption of the display sustained according to the sustain frequency can then conform to a rated power consumption Pr.

It should be noted that despite the power consumption of the plasma display panels can be controlled under a certain value by means of the foregoing automatic control power curve, different plasma display panels using the same automatic control power curve will have different power consumption due to different manufacturing processes thereof. As shown in FIG. 1, the plasma display panels A, B inputted by the same image signal are driven according to the same display loading and the sustain frequency. Despite the plasma display panels A, B using the same automatic control power curve 102, the practical power consumption Pa of the plasma display panel B is higher than the rated power consumption Pr due to the different electrical characteristics resulted from different manufacturing processes for the plasma display panels.

In order to solve the aforementioned problem, the method often used is to adjust the drive work voltage in order for the power consumption to have the same rated value. FIGS. 2A to 2C are relationship diagrams of a work voltage of a scan electrode and a sustain electrode of a conventional plasma display panel. Referring to FIG. 2A to 2C, the work voltage Vset is within a normal display margin 202 originally. As shown in FIG. 2B, when the power consumption of the panels is too high, the work voltage Vset will be lowered to conform to the rated power consumption. However, under the condition, the adjusted work voltage is outside the normal display margin 202(Vset_new1) or is at the border of the normal display margin 202(Vset_new2). Additionally, as shown in FIG. 2C, although the work voltage Vset_new 2 is at the border of the normal display margin 202, the work voltage Vset_new 2 may fall outside the varied normal display margin 204 when the normal display margin 202 varies because the panels are being used for a long time. Therefore, when the work voltages Vset_new1 and Vset_new2 are driven, the brightness of the plasma display panels is not desirable or even abnormal. Consequently, the yield rate or the life span of the plasma display panels is reduced.

### SUMMARY OF THE INVENTION

Accordingly, the present invention is directed to a driving method of a plasma display panel, used for controlling a power consumption of plasma display panels to conform to a rated power consumption.

The present invention is also directed to a driving circuit of a plasma display panel, adapted for gain-controlling a display loading to adjust a power consumption of the plasma display panel, and for overcoming the power consumption deviation between different display panels in order to produce a more uniform display.

According to an embodiment of the present invention, a driving method of a plasma display panel is provided. The driving method is adapted for power control of a plasma display panel by an automatic control power curve, wherein the automatic control power curve is a relationship curve of a display loading and a sustain frequency of the plasma display panel. The driving method includes inputting an image signal into the plasma display panel. A first display loading is obtained according to the image signal. The first display loading is then multiplied by a gain constant to obtain a second display loading. Thereafter, the plasma display panel is driven according to the second display loading for the power consumption of the plasma display panel to conform to a rated power consumption.

According to an embodiment of the present invention, a driving circuit of a plasma display panel is disclosed, wherein the driving circuit is adapted for controlling a power consumption of a plasma display panel. The driving circuit includes, for example, a calculating unit, a gain unit, and a control unit, wherein the calculating unit is used for outputting a first display loading according to an image signal. The gain unit is used for receiving the first display loading, wherein the first display loading is multiplied by a gain constant to output a second display loading. In addition, the control unit is used for receiving the second display loading to correspondingly output a sustain frequency, wherein the power consumption of the plasma display panel can conform to a rated power consumption based on the sustain frequency.

According to an aspect of the present invention, the driving method and the driving circuit of a plasma display panel can gain-control the inputted display loading according to the electrical characteristics of plasma display panels. Further, the corresponding sustain frequency can be obtained from the automatic control power curve so that the power consumption of the plasma display panels can conform to a rated value.

### BRIEF DESCRIPTION OF THE DRAWINGS

FIG. 1 is a diagram illustrating the relationship between the sustain frequency and the display loading when a conventional plasma display panels is driven.

FIG. 2A to 2C are diagrams illustrating the relationship between a work voltage of a scan electrode and a sustain electrode of a conventional plasma display panel.

FIG. 3 is a flow chart of a process flow of a driving method of a plasma display panel according to one embodiment of the present invention.

FIG. 4 is an automatic control power curve applied for a driving method of a plasma display panel according to one embodiment of the present invention.

FIG. 5 is a schematic view of a drive circuit of a plasma display panel according to one embodiment of the present invention.

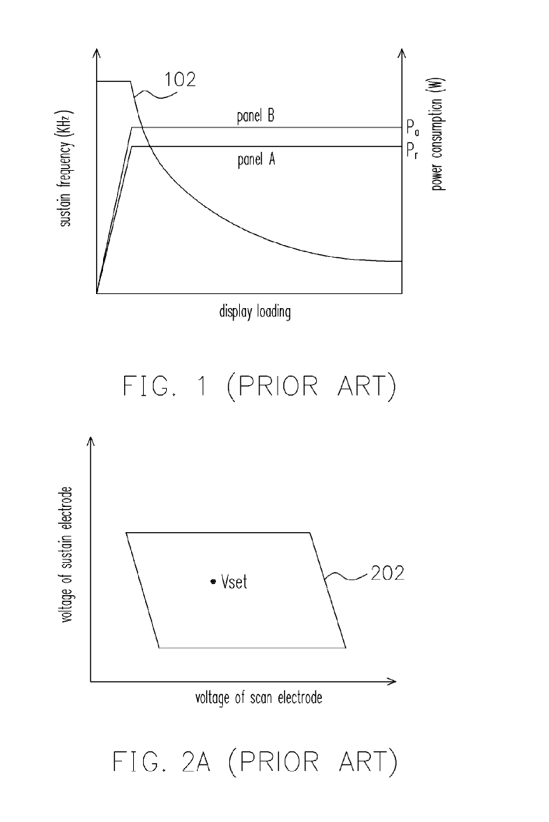

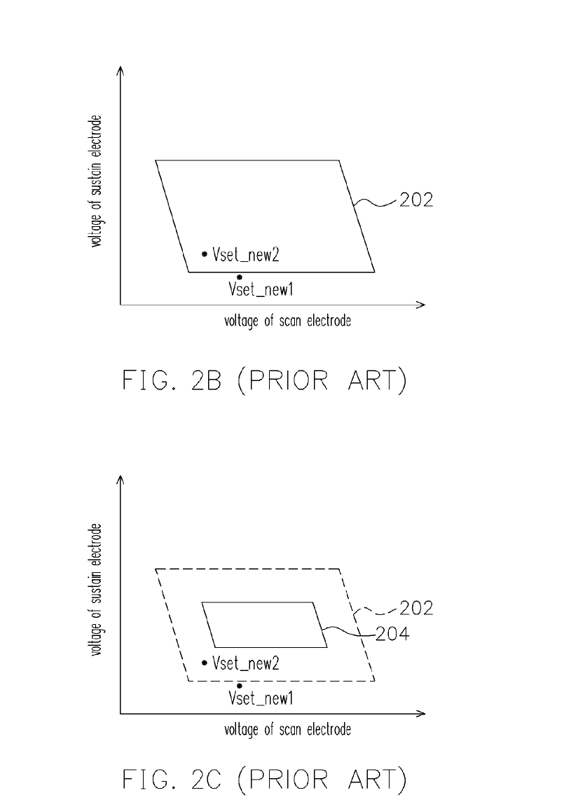

### DESCRIPTION OF THE EMBODIMENTS

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

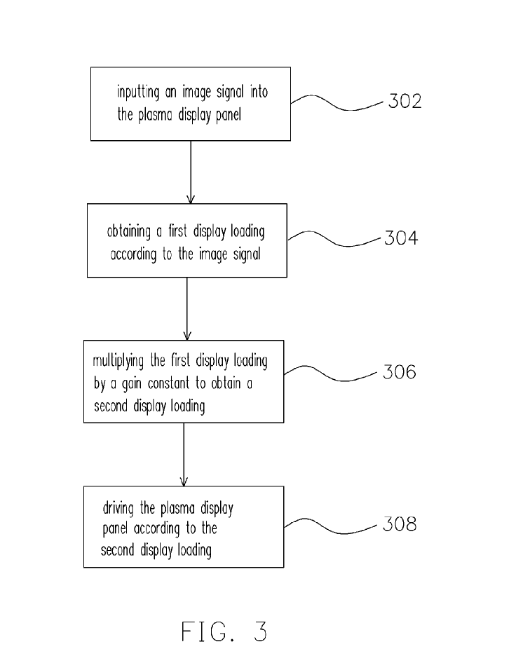

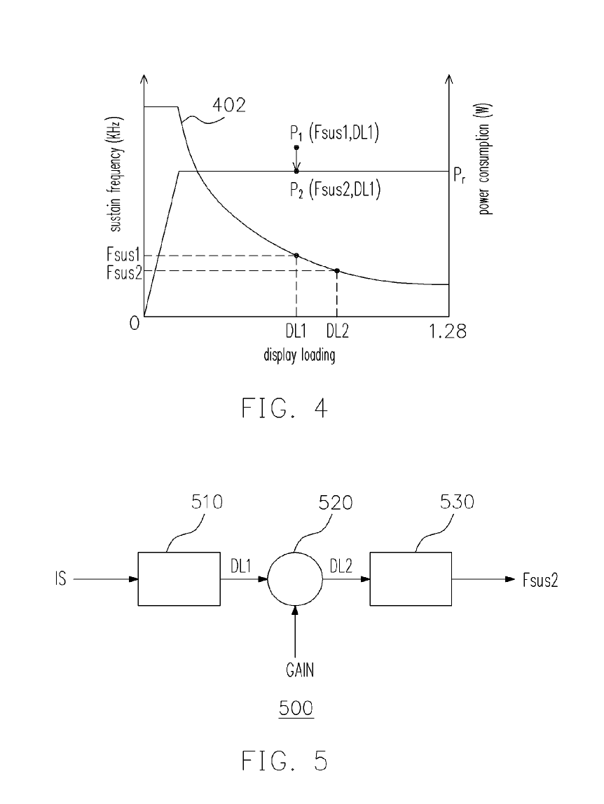

FIG. 3 is a flow chart of a process flow of a driving method of a plasma display panel according to one embodiment of the present invention. FIG. 4 is an automatic control power curve applied for a driving method of a plasma display panel according to one embodiment of the present invention. As shown in FIGS. 3, 4, the automatic control power curve 402 is for example, a monotonic curve comprising a plurality of display loading and sustain frequencies. The power of the plasma display panels can be controlled by the display loading and the corresponding sustain frequency on the automatic control power curve 402. The driving method of a plasma display panel of the present invention includes the following steps.

An image signal is transmitted into a plasma display panel (step 302). A first display loading is then obtained according to the image signal (step 304), wherein the quantity of lightening sustain pulses in a picture frame is dependent on the first display loading. As shown in FIG. 4, a first display loading DL1 is obtained from the image signal, and a corresponding first sustain frequency Fsus1 is obtained with reference to the automatic control power curve 402. However, because of different electrical characteristics of the display panels, an actual power consumption P1 produced by the first sustain frequency Fsus1 deviates from the rated power consumption Pr.

Accordingly, the first display loading DL1 is multiplied by a gain constant to obtain a second display loading DL2 (step 306). When the plasma display panels are quality control tested for lightening, a test signal is inputted to the plasma display panels. The gain constant value obtained based on the calculation on the power consumption determined during lightening test and the rated power consumption. Hence, the gain constant is different due to the different electrical characteristics of plasma display panels. For instance, when the power consumption P1 generated from the first sustain frequency Fsus1 is larger than the rated power consumption Pr, the gain constant will be larger than 1. Accordingly, the second display loading DL2 will be larger than the first display loading DL1.

Thereafter, the plasma display panels are driven according to the second display loading DL2 (step 308). A second sustain frequency Fsus2 corresponding to the second display loading DL2 is obtained from the automatic control power curve 402. Because the second display loading DL2 is larger than the first display loading DL1, the second sustain frequency Fsus2 is smaller than the first sustain frequency Fsus1. Accordingly, when the plasma display panels are driven by the second sustain frequency Fsus2 and the first display loading DL1, the number of the sustain pulses allocated to each of the sub-fields is fewer, and the power consumption P2 generated will conform to the rated power consumption Pr.

According to the aforementioned disclosure, a driving circuit of a plasma display panel of the present invention is used for the foregoing driving method to control the power consumption of the plasma display panels. FIG. 5 is a schematic view of a drive circuit of a plasma display panel according to one embodiment of the present invention. Referring to FIGS. 4 and 5, for example, the drive circuit 500 includes a calculating unit 510, a gain unit 520, and a control unit 530, wherein the calculating unit 510 receives an image signal IS, and a first display loading DL1 is calculated from the image signal IS. Additionally, the gain unit 520 receives the first display loading DL1. By multiplying the first display loading DL1 with a gain constant GAIN, a second display loading DL1 is obtained and outputted. The gain constant is obtained during the quality control test and is stored in a memory. Furthermore, the control unit 530 is used for receiving the second display loading DL2, and for storing the automatic control power curve 402, wherein in reference to the automatic control power curve 402, a sustain frequency Fsus 2 corresponding to the second display loading DL2 is obtained for driving the plasma display panels.

In accordance with the present invention, the display loading is gain-controlled according to the electrical characteristics of the plasma display panels. If the original power consumption is too high, the display loading is increased by the gain constant in order to maintain a lower sustain frequency for the power consumption to conform to a rated value. Accordingly, the driving method and the driving circuit of a plasma display panel of the present invention provide at least the following characteristics and advantages:

1. By adjusting the power consumption of the panels with the gain control of the display loading, the conventional adjustment method of varying the work voltage can be replaced. In a practical application, the power control can be optimized by adjusting the gain-control of the display loading and the work voltage.

2. The power consumption can be adjusted by changing the display loading. Therefore, the situation when the work voltage falls outs the normal display margin can be avoided. Accordingly, the yield rate and the life span of the panels can be enhanced effectively.

3. The different gain constants can be provided by plasma display panels of different characteristics in order to conform to the rated power consumption. As a result, the power consumption of each panel will be more even.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A driving method of a plasma display panel, adapted for power control of a plasma display panel with an automatic control power curve, wherein the automatic control power curve is a relationship curve of a display loading and a sustain frequency of the plasma display panel, the driving method comprising:
inputting an image signal into the plasma display panel;
obtaining a first display loading according to the image signal;
multiplying the first display loading by a gain constant to obtain a second display loading; and
driving the plasma display panel according to the second display loading for a power consumption of the plasma display panel to conform to a rated power consumption.

2. The driving method of claim 1, wherein the step of driving the plasma display panel by the second display loading comprises:
obtaining a sustain frequency corresponding to the second display loading according to the automatic control power curve; and
sustaining a display output according to the sustain frequency.

3. The driving method of claim 1, wherein the step of getting the gain constant comprises:
inputting a test signal to the plasma display panel to measure a test power consumption; and
obtaining the gain constant according to the rated power consumption and the test power consumption.

4. A driving circuit of a plasma display panel, adapted for controlling a power consumption of a plasma display panel, the driving circuit comprising:
a calculating unit, used for outputting a first display loading according to an image signal;
a gain unit, used for receiving the first display loading, and the first display loading is multiplied by a gain constant to output a second display loading; and
a control unit, used for receiving the second display loading to correspondingly output a sustain frequency, wherein the power consumption of the plasma display panel conforms to a rated power consumption based on the sustain frequency.

5. The drive circuit of claim 4, wherein an automatic control power curve is stored in the control unit, and the automatic control power curve comprises the relationship curve of the display loading and the sustain frequency of the plasma display panel.
